(19) United States
(12) Patent Application Publication
(10) Pub. No.: US 2013/0067732 A1
(43) Pub. Date: Mar. 21, 2013

(54) Method for Installing a Pipeline While Minimizing Associated Ground Disturbance

(71) Applicant: Anadarko Petroleum Corporation, The Woodlands, TX (US)

(72) Inventor: Ali G. Kadaster, The Woodlands, TX (US)

(73) Assignee: ANADARKO PETROLEUM CORPORATION, The Woodlands, TX (US)

(21) Appl. No.: 13/675,487

(22) Filed: Nov. 13, 2012

Related U.S. Application Data
(63) Continuation of application No. 13/437,201, filed on Apr. 2, 2012, now abandoned.
Application No. 13/437,201 is a continuation of application No. 13/214,513, filed on Aug. 22, 2011, now abandoned.
Application No. 13/214,513 is a continuation of application No. 12/984,353, filed on Jan. 4, 2011, now abandoned.
Application No. 12/984,353 is a continuation of application No. 12/786,237, filed on May 24, 2010, now abandoned.
Application No. 12/786,237 is a continuation of application No. 12/617,204, filed on Nov. 12, 2009, now abandoned.
Application No. 12/617,204 is a continuation of application No. 12/432,164, filed on Apr. 29, 2009, now abandoned.
Application No. 12/432,164 is a continuation of application No. 12/287,204, filed on Oct. 7, 2008, now abandoned.
Application No. 12/287,204 is a continuation of application No. 12/077,213, filed on Mar. 18, 2008, now abandoned.
Application No. 12/077,213 is a continuation of application No. 11/899,269, filed on Sep. 5, 2007, now abandoned.
(60) Provisional application No. 60/842,267, filed on Sep. 5, 2006.

(51) Int. Cl. B23P 19/00

(52) U.S. Cl. 29/700

(57) ABSTRACT

A method of installing a pipeline under land or relatively shallow water with minimal disturbance of the surface environment is provided wherein a subsurface, horizontal hole is drilled between spaced apart sites established between a source location and a destination location, and pipe segments are then run through the horizontal hole to connect the locations. The method drills the horizontal hole by positioning a first horizontal drilling rig at a source location and a second horizontal drilling rig at a destination location, and the using the rigs to drill a horizontal hole between the source and destination locations by means of a transverse reaming process.

### RELATED APPLICATION DATA

The present application is a continuation of U.S. Non-Provisional application Ser. No. 13/437,201 filed Apr. 2, 2012, still pending, which is a continuation of U.S. Non-Provisional application Ser. No. 13/214,513 filed Aug. 22, 2011, now abandoned, which is a continuation of U.S. Non-Provisional application Ser. No. 12/984,353 filed Jan. 4, 2011, now abandoned, which is a continuation of U.S. Non-Provisional application Ser. No. 12/786,237 filed May 24, 2010, now abandoned, which is a continuation of U.S. Non-Provisional application Ser. No. 12/617,204 filed Nov. 12, 2009, now abandoned, which is a continuation of U.S. Non-Provisional application Ser. No. 12/432,164 filed Apr. 29, 2009, now abandoned, which is a continuation of U.S. Non-Provisional application Ser. No. 12/287,204 filed Oct. 7, 2008, now abandoned, which is a continuation of U.S. Non-Provisional application Ser. No. 12/077,213 filed Mar. 18, 2008, now abandoned, which is a continuation of U.S. Non-Provisional application Ser. No. 11/899,269 filed Sep. 5, 2007, now abandoned, which claims the benefit of prior U.S. Provisional Application No. 60/842,267, filed Sep. 5, 2006.

### FIELD OF THE INVENTION

The present invention relates generally to pipeline installation technologies, and in a specific, non-limiting embodiment, to a method for installing a pipeline system without trenching or otherwise significantly disturbing the ground surface as occurs in conventional pipeline installation operations. For purposes of this application, the term “pipeline” shall refer to any and all types of conduit capable of carrying one or more of any type of fluids (including liquids and gasses solids, slurried solids, power sources or relays, utilities, communications, data lines, etc.

### BACKGROUND

A wide variety of industrial applications require pipeline access in order to safely and efficiently practice associated technologies. For example, utility services, fiber optics installations, and water transportation facilities all require pipeline access in order to carry out their various business operations.

Other important fields requiring pipeline installations include oil and gas exploration and production technologies. However, many potential oil and gas exploration and production sites are significantly constrained by environmental considerations and other special circumstances that make transportation and installation of pipeline equipment difficult or impossible to readily achieve.

For example, oil and gas reserves are often found in terrain with near-surface water accumulations, such as swamps, captive lakes, and permafrost regions. In the case of swamps, the ground is generally too soft to support trucks and other heavy equipment required to deliver and install pipeline trenching and support equipment. Captive lakes can also be troublesome, especially when disposed between terminal points of a pipeline installation; in such cases, the pipeline generally has to be re-routed around the lake, which can greatly increase the complexity and total expense of the operation. In permafrost regions, heavy equipment can be supported only during certain months of the year, in particular, those winter months when the ground surface is securely frozen.

Moreover, many regions where oil and gas reserves are found are so environmentally sensitive that surface access by transport vehicles can damage the underlying terrain or otherwise affect wildlife breeding areas and migration paths. Such environmental problems can be particularly acute in arctic tundra and permafrost regions, where road construction is often prohibited or limited to temporary seasonal access.

In other potential production sites, contiguous rights of way and/or drilling and transportation permits cannot be easily obtained, and in still other areas, gorges or other interfering terrain features effectively preclude cost-efficient drilling and production of oil and gas reserves. For example, it is sometimes necessary for political or geographical reasons to install or maintain pipelines, or portions thereof, in submerged trenches or well bores disposed beneath the ground surface of a town or city (or under a lake or sea, or across seashores or a beach line, etc.) in order to overcome challenges posed by operations performed in a particular operating environment.

Wherever a well is drilled and produced, the resultant oil or gas must eventually be transported from the wellhead to a collection, storage or transportation facility. Currently, the most common method of transporting the oil or gas is by means of a pipeline. Under normal circumstances, pipelines are run above ground and affixed to a series of braces set in trenches dug into a ground surface. Other pipelines, such as those that run shorter distances under obstacles such as buildings or rivers, are typically carried out by large-scale tunneling operations or by known horizontal drilling technology. However, such tunneling operations are usually much more expensive and complicated than trenching, and thus pipelines are generally disposed above surface trenches whenever possible.

Since tunneling is generally undesirable for the reasons discussed above, and since it is frequently prohibitively difficult to set trenches in desirable locations, there is presently a widespread need for a method of installing pipelines that is independent of either trenching or conventional tunneling technologies.

### SUMMARY OF THE INVENTION

According to a method of the present invention, a plurality of multipurpose, interconnectible platform modules are transported to and elevated above a number of predefined locations spaced apart along a pipeline route established between a source location and a destination location. The platform modules can be configured to be transportable by aircraft or special purpose vehicles adapted to cause minimal harm to the environment, if necessary. Horizontal drilling rigs including coiled drilling pipe are then installed on at least some of the platforms. After a first drilling rig is installed, a subsurface, a starter hole is drilled between a first platform and an adjacent, second platform. After a first length of coiled tubing or drilling pipe is received at the second platform location, it is attached to a second rig, which is preferably a push/pull rig, and then reeled back and forth between the source and destination locations in a transverse reaming fashion, so that the original hole is circumferentially enlarged as a result of the reaming process. After the hole between the source and receiving locations has been reamed to a desired circumference, segments of pipe are then introduced into the hole and interconnected so as to form a contiguous, subsurface pipeline segment. When the desired segment has been fully installed, the platform modules may be disassembled and removed, or transported to other locations to lay new segments of the line. While maintenance and security ports may be left in place after the platform modules have been removed, the pipeline itself is disposed completely underground, and need only permit access from above at the terminal points of the line. For example, after a pipeline segment has been installed beneath an associated ground surface, one or more partial platforms can be left at points along the line in order to house utilities, control valves, a pig launch, a recovery assembly, etc. In some embodiments, the points at which such structures are disposed along a line are predetermined, whereas in other embodiments such points are determined during the course of operations.

### BRIEF DESCRIPTION OF THE DRAWINGS

FIG. 1 depicts aspects of a pipeline installation method according to a first embodiment of the present invention.

FIG. 2 depicts aspects of a pipeline installation method according to a second embodiment of the present invention.

FIG. 3 depicts aspects of a pipeline installation method according to a third embodiment of the present invention.

FIG. 4 depicts aspects of a pipeline installation method according to a fourth embodiment of the present invention.

FIG. 5 depicts aspects of a pipeline installation method according to a fifth embodiment of the present invention.

### DETAILED DESCRIPTION OF THE INVENTION

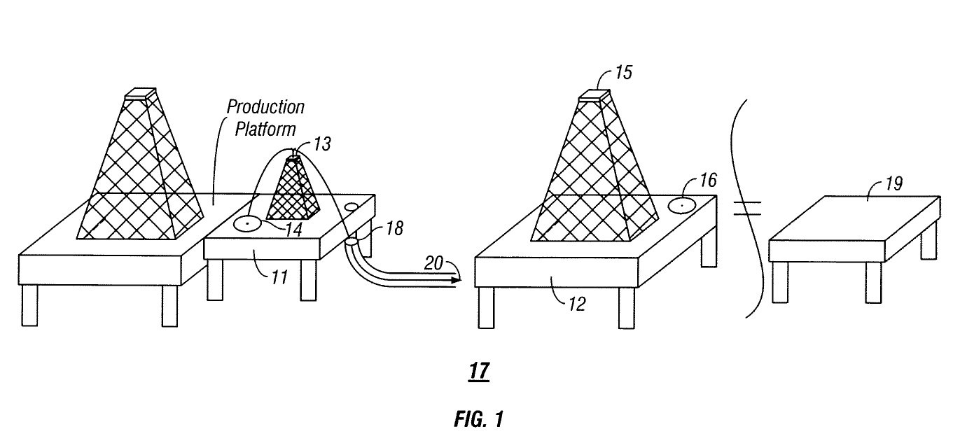

Referring now to FIG. 1, there is illustrated a specific, non-limiting embodiment of a pipeline installation method according to the present invention. In FIG. 1, a source platform 11 is positioned nearby and adjacent to a destination platform 12. A first horizontal drilling rig 13 and a reel 14 of coiled tubing, drilling pipe, jointed pipe, etc., are installed on said source platform 11, and a second horizontal drilling rig 15 having a blank reel adapted to receive said coiled tubing drilling pipe is installed on destination platform 12.

According to one embodiment of the invention, each of said first horizontal drilling rig 13 and said second horizontal drilling rig 15 is a pusher/puller rig, adapted to alternatively advance and pull said coiled tubing or drilling pipe into and out of a horizontal hole established between said source and destination platforms.

When the method of the present invention is initiated, a length of said coiled tubing or drill pipe is fitted with a drill bit (not shown) and then introduced into a ground surface 17 using said first horizontal drilling rig 13 so as to create a small starter hole 18 through which additional portions of said coiled tubing drill pipe can be advanced.

According to a further embodiment of the invention, an advanced length of coiled tubing drill pipe can be withdrawn from said horizontal hole in order to refit said coiled tubing or drill pipe with a different drill bit, for example, as would be required if the first drill bit were to break. The drill bit employed to cut the starter hole 18 might also need to be replaced with a bit having a harder leading edge in cases where the terrain features encountered by the bit become harder as the hole is dug deeper or horizontally further along into the ground surface 17.

Those of ordinary skill in the appropriate arts will appreciate that while each of said source platform 11 and destination platform 12 are depicted in FIG. 1 as comprising elevated modular platforms, each of said first and second horizontal drilling rigs 13, 15 may instead be supported on a gravel pad, a matting, an ice pad, a hovercraft, a truck or any other appropriate support structure.

The distance at which destination platform 12 is spaced apart from source platform 11 and the depth and angle of declination at which starter hole 18 is drilled are largely dependent upon strategic considerations imposed by the drilling site. For example, in cases where the presently disclosed method is employed primarily for regulatory reasons, e.g., where an operator is uninhibited by any particular terrain or environmental features but a drilling permit requires the pipeline to be fully submerged beneath the ground surface, primary considerations might simply include the ease and safety of the operation. On the other hand, where an operation calls for installing the pipeline system beneath an intervening terrain feature (e.g., a lake or other low-lying accumulation of ground water, a town, a small inland sea, etc., it will be desirable to calculate both the minimum depth at which the pipeline must be submerged and the minimum angle at which the line can be arced relative to the normal plane of the ground surface 17 in order to determine an appropriate spacing distance between said source and destination platforms 11, 12 and an appropriate vertical depth to which the starter hole must be dug. For sighting purposes, it might also be desirable to dispose one or more directional beacons (not shown) at appropriate intervals on the ground surface 17 in order to ensure that the subsurface line is being established safely within predetermined operational parameters.

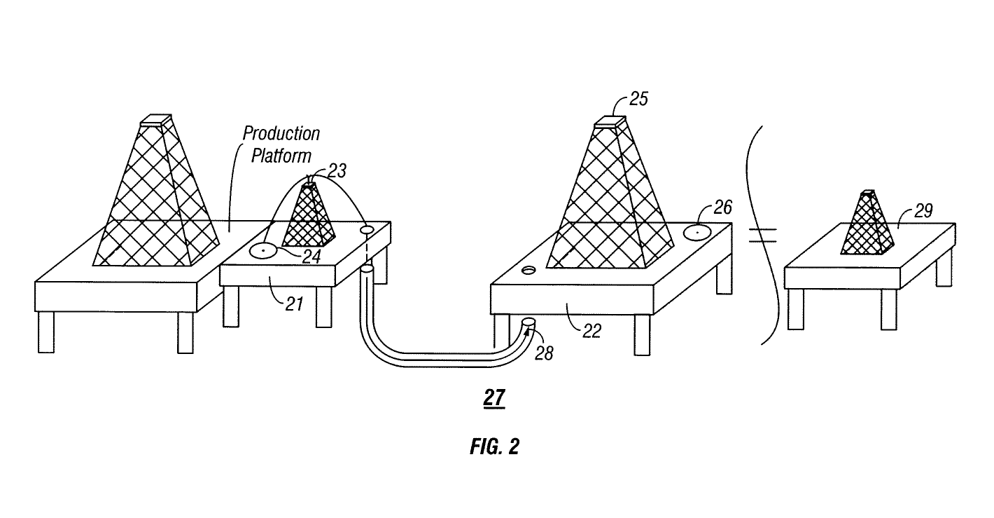

As seen in the embodiment of the invention depicted in FIG. 2, the entire length of an appropriately sized and angled underground horizontal hole 29 is drilled from source platform 21 in the direction of destination platform 22. Using conventional instruments and techniques, horizontal drilling rig 23 is operated as a pusher rig to advance coiled tubing or drill pipe into the ground surface 27 until it emerges under or adjacent to destination platform 22. This initial traversal of the distance between source platform 21 and destination platform 22 is carried out using a drilling bit having a relatively small diameter, which for purposes of the present discussion shall be defined herein as diameter A.

In a presently preferred embodiment of the invention, the vertical depth of the underground horizontal hole 29 relative to the normal plane of the ground surface 27 is selected so as to provide for good subsurface soil or rock stability. For example, in arctic regions the underground horizontal hole 29 should be disposed well below the thaw zone so as to ensure that the pipeline system will remain submerged when surface ice melts in warmer seasons. According to one embodiment of the invention, the depth of the horizontal hole is less than about 500 feet, whereas in other embodiments the depth is greater than about 500 feet.

According to a presently preferred embodiment of the invention, the subsurface horizontal hole 29 is disposed between 20 and 300 feet underground relative to the normal plane of the ground surface 27. In still other embodiments, the depth of horizontal hole 29 is selected taking into consideration certain other environmental and safety concerns. For example, subsurface horizontal hole 29 may be drilled between or below interposed impermeable ground formations in order to contain any line leakage that may occur.

In any event, when horizontal hole 29 is finally disposed either under or closely adjacent to destination platform 22, the coiled tubing drill pipe is adjusted to return the hole to the surface, as seen illustrated in FIG. 2. The drill bit is then removed and coiled tubing drill pipe is at least partially gathered at the destination platform 25 and then reeled about a blank receiving spool 26.

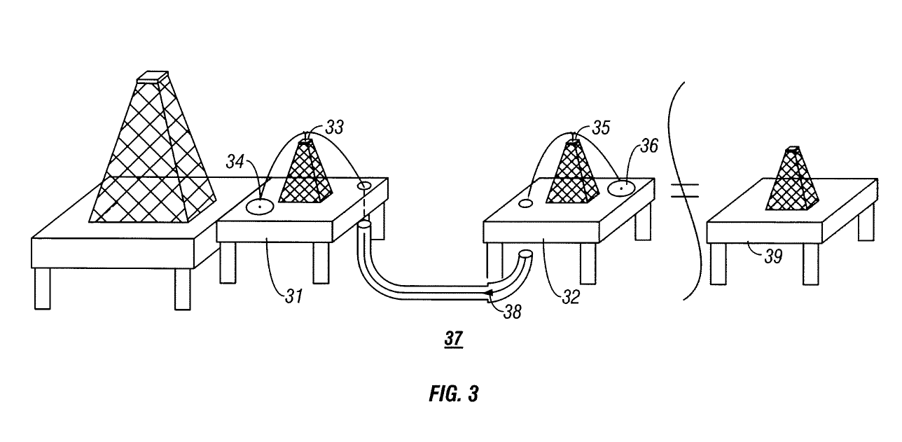

According to an embodiment of the invention depicted in FIG. 3, after the initial hole 39 is completed between source platform 31 and destination platforms 32, and the coiled tubing has been at least partially gathered and spooled onto a reel disposed on destination platform 35, the bore diameter of the horizontal hole is thereafter further enlarged by a subsequent traversals of the coiled tubing back and forth through the hole. In a presently preferred embodiment, this subsequent traversal is preceded by first removing of the aforementioned small drill bit having a diameter A after the entirety of horizontal hole 39 has been established, and replacing it with a bit having a relatively larger diameter A′. As seen in FIG. 3, horizontal drilling rig 31 is in this step operated as the puller rig to pull the coiled tubing and the larger diameter drill bit back toward platform 31; in certain embodiments of the invention, platform 32 is also employed to push the bit back toward source platform 31. The back and forth pushing and pulling process is repeated with increasingly larger drill bits, e.g., bits having a diameter A″, A′″, . . . , until the diameter of the horizontal hole established between source platform 31 and destination platforms 32 is circumferentially large and uniform enough to accommodate a pipeline. Depending on the particular application in question, it may be desirable to install a number of interconnected pipe segments, so that the line remains secure during and after installation. In other embodiments of the invention, concentric pipe segments are installed, so that any leakage that may occur is contained within the line, or so the innermost portions of the line are better insulated against the elements.

Those of ordinary skill in the applicable arts will also appreciate that while certain river crossings have in the past utilized horizontal drilling machines to sequentially enlarge a developing bore in order to pull through a final pipeline segment, a further embodiment of the present invention comprises disposition of a plurality of rigs on a plurality of platforms or other drilling structures, which, either simultaneously or sequentially, work in a cooperative manner such that a first rig disposed on a first platform drills a wellbore towards a second rig disposed on a second platform, while the second rig on the second platform is used to drill a separate wellbore back towards the first platform, etc.

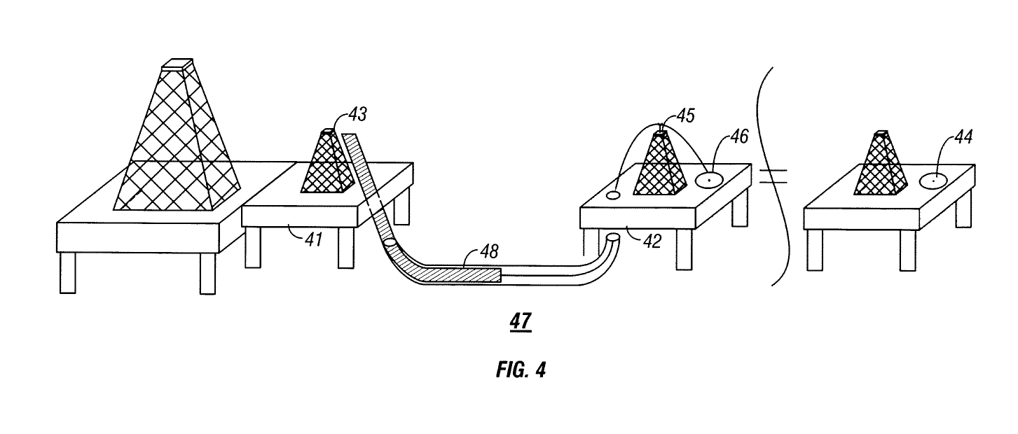

Then, as seen in the embodiment of the invention depicted in FIG. 4, a pipeline 43 is pushed from source platform 41 toward destination platform 42 through the interior of the subsurface horizontal hole. According to one embodiment of the invention, destination rig 42 is also employed to pull the pipeline toward platform 42.

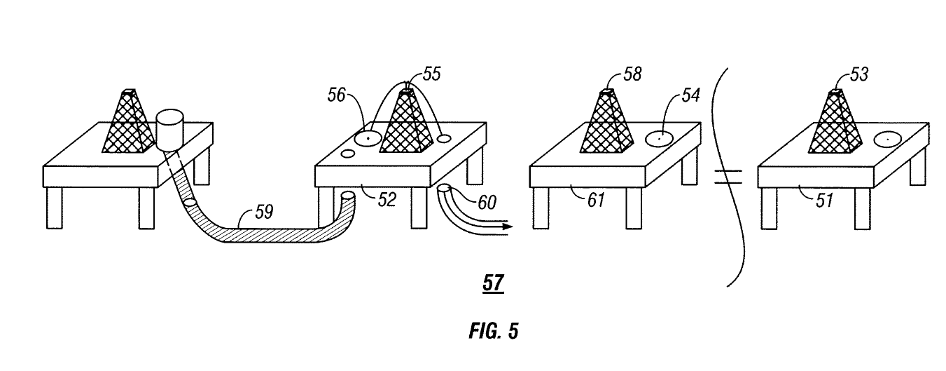

As seen in the embodiment of the invention depicted in FIG. 5, after a desired pipeline segment has been completed, the source platform and its associated horizontal drilling rig and reel are removed from the site and then transported to another location in order to complete successive stages of the pipeline. The equipment and platform modules may then be transported using, for example, any appropriate ground, air or water vehicle, or in any other appropriate manner dictated by the operating environment.

At this point, destination rig 52 can be employed to initiate the drilling of a second horizontal hole, so that a new segment of pipeline can be run to still another platform (in which case destination platform 52 effectively becomes the source platform for the next stage of installation), in the manner described above with respect to FIGS. 1-5.

The process is continued until a complete pipeline is run to a main pipeline, or terminal, or storage facility or other desired destination. According to one embodiment of the invention, the connections between pipeline segments are made at the surface, so as to permit access to the line for running cleaners, to permit safety inspections, etc. However, the connections may also be disposed in pits, basins or other underground locations, so that the entirety of the installation is disposed beneath the ground surface 54.

While the method of the present invention has been illustrated as a serial process in which horizontal holes are drilled and the pipeline segments are run sequentially from a first location to a second location, and then from the second location to a third, and so on, the method can also be performed as a parallel process in which horizontal holes are drilled and pipeline segments are run substantially simultaneously between multiple, spaced apart locations. Additionally, concentrically disposed pipelines may be installed to minimize temperature effects and to contain leakage. Moreover, holes of virtually any shape and size, e.g., a hole having a catenary or flattened parabolic shape and an essentially horizontal segment disposed between terminal points, or any other size or shape of hole that will admit to practice of the present invention, can be substituted in place of the previously mentioned horizontal hole.

In short, the presently disclosed pipeline construction method permits assembly of numerous small, mobile platform modules from which segmented pipeline portions may be flexibly installed, wherein the platforms may thereafter be transported to, assembled and elevated above, various other locations along a predefined pipeline route so that further segments of the line can be constructed, all while causing only minimal and temporary disturbance to the affected ground surface. Horizontal directional drilling techniques are combined with a transverse hole reaming process to install adjacent portions of the pipeline along the route.

In some embodiments, small platforms or other work stations are left disposed along the line in order to house utilities, pipeline controls, valves, a pig launch, recovery stations, etc., at locations determined either in advance of operations or in response to situational modifiers that become known as operations are being carried out.

The foregoing specification is provided for illustrative purposes only, and is not intended to describe all possible aspects of the present invention. Moreover, while the invention has been depicted and described in detail with respect to several exemplary embodiments, those of ordinary skill in the pertinent arts will appreciate that minor changes to the description, and various other modifications, omissions and additions may also be made without departing from either the spirit or scope thereof.

1. A system for installing and maintaining a pipeline, said system comprising:
a first source platform disposed at a first drilling site, wherein said first source platform further comprises a first drilling means;
a first receiving platform disposed at a second drilling site, wherein said first receiving platform further comprises a second drilling means;
a first directional drilling rig disposed on said first source platform;
a second directional drilling rig disposed on said first receiving platform; and
a plurality of additional platform structures disposed between said first source platform and said first receiving platform.
